(19) United States
(12) Patent Application Publication
(10) Pub. No.: US 2004/0267966 A1
(43) Pub. Date: Dec. 30, 2004

(54) Application specific internet system

(76) Inventors: Douglas W. Wang, Hsinchu (TW); Cheng-Ai Huang, Hsinchu (TW); Peng-Cheng Lai, Banchiau City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/603,866

(22) Filed: Jun. 26, 2003

(51) Int. Cl. G06F 15/16

(52) U.S. Cl. 709/250; 709/230

(57) ABSTRACT

The present invention provides an application specific Internet system (ASIS) comprising one or multiple specific application Internet servers and multiple application specific Internet device (ASID) for specific applications comprising a network interface chip being connected to an Internet server, wherein the network Internet chip being connected to a microprocessor at the same time for handling general protocols and managing control commands and bi-directional data transmission required by particular applications between the server, whereby the display and control module can show and browse the messages, audio input/output module can play music, encode and decode voice, program memory stores firmware, data memory temporarily stores music, voice and display data, non-volatile memory stores data in no power circumstances, and further comprising a power supply unit (or battery set) which provides each hardware component with required operational power. Therefore the present invention is an independent device, which can make sustained Internet connection to specific application Internet servers for Internet messaging and management in any places where the Internet access is available by using of a self-provided power supply or battery set, and therefore having the advantages of easy operation and convenient usage.

### FIELD OF THE INVENTION

The present invention relates to an Application Specific Internet System (ASIS), and more particular to an Internet system whereby bidirectional Internet messaging is implemented by a system containing one or multiple specific application Internet servers and more than one application specific Internet devices. The device is stand-alone and works independently as a node in Internet environment.

### BACKGROUND OF THE INVENTION

The development of the Internet is getting more and more popular with time, and information searching, data downloading, email sending, data transferring or chatting by means of computers on the Internet have become indispensable assistants for all users in their careers and lives. Therefore, the goal of instant transmission for important messages has been attained by way of computers and Internet. Presently, power-on status of the computer (or host) and connection status of the network system has to be maintained as receiving Internet messages by employing personal computers. That is, the computer (or host) has to be booted and held on even for emailing or Internet messaging merely, which is somehow power-wasting.

A conventional Internet device operated in the Internet environment needs to be connected to a computer or embedded directly inside a computer host as software application program, so that the computer may take care of those various protocols for any incoming Internet message. Thus, the user must keep the computer in power-on status so as to make use of the new Internet device for message receiving and delivering. Furthermore, due to the setting difference between each Internet provider, it is necessary for a conventional Internet device to be accommodated to various Internet settings, and thereby appearing to be complicated and not easy to use.

Consequently, the present invention improves the conventional technique, and provides a simple and cheap application specific Internet system for extensively application which merely deals with particular protocols by cooperating with an application program from the server end.

### SUMMARY OF THE INVENTION

It is a main object of the present invention to provide an application specific Internet device that can work independently and communicate with specific application servers located in Internet to receive or deliver messages, such as email, voice mail, telephony, global news, real-time stock quotations, weather reports, and so on, therefore having the effects of easy operation and convenient usage.

It is another object of the present invention to provide an application specific Internet device that merely accesses specific Internet messages by adopting particular and easy protocols to communicate with particular application programs of specific application Internet servers, therefore having the advantages of simple structure and low cost.

It is still another object of the present invention to allow a user to enter a designate setting of Internet parameters beforehand as initialize an application specific Internet device in both automatic and manual manners, so as to deal with different settings from different Internet providers for the purpose of getting connected to the Internet anytime.

It is again another object of the present invention to provide an application specific Internet device that is capable of performing simple personal management tools such as calendar, address book, alarm clock, and so on.

It is again object of the present invention to provide a clustered server structure consisting of one or more specific application Internet servers. Application can be merged on one server for less devices environment, or can be separated and installed into different servers for expansion flexibility.

To achieve the above objects, the application specific Internet system of the present invention consists of one or more specific application Internet servers and more than one application specific Internet devices.

The application specific Internet device comprises a network interface chip, which provides a connection to one or more Internet servers, and a microprocessor for handling Internet and proprietary protocols and managing the operational flow control between each hardware modules, and a LCD display and control module for enabling the display of message contents, and voice processor for voice encode, decode, compression and decompression, and further comprises a power supply unit which provides each hardware components with required power. The application specific Internet device can function without being connected to a computer or host, and bi-directional communication can be accomplished independently.

Furthermore, the specific application Internet server structure of the present invention may consist of one or more servers. For small amount of application specific Internet device environment, all application server programs can reside in one server and provide services to the devices. When the amount of devices grows and the loading exceeds one server's capabilities, application server programs can individually reside in different servers located everywhere in the Internet. At this time, one among all servers will be set as main server to manage and coordinate all other servers.

Those objects, technical contents, features and effects attained of the present invention described above will be appreciated more easily in the following detailed description of specific embodiments thereof, as illustrated by the accompanying drawings.

### BRIEF DESCRIPTION OF THE DRAWINGS

FIG. 1 is a structural block schematic diagram of application specific Internet device (ASID) showing an embodiment of the present invention.

FIG. 2 is a structural block schematic diagram of application specific Internet system (ASIS) showing an applied embodiment of the present invention.

FIG. 3 is a structural block schematic diagram of application specific Internet system (ASIS) showing another applied embodiment of the present invention.

### DETAILED DESCRIPTION OF THE PREFERRED EMBODIMENTS

The present invention is an application specific Internet system (ASIS) consists of one or more specific application Internet servers and more than one application specific Internet devices (ASID). The ASID is a stand-alone device with easy operation and inexpensive price. That is, the ASID can provide sustained Internet connection and Internet message management between specific application Internet servers alone by making use of a self-provided power supply or battery set.

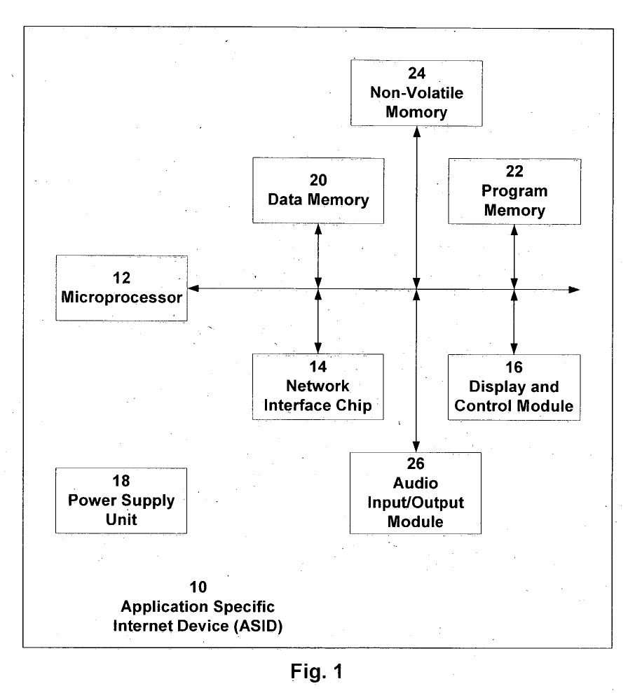

FIG. 1 shows a structural schematic diagram of application specific Internet device (ASID) according to an embodiment of the present invention. The application specific Internet device 10 comprises a microprocessor 12 for handling general and particular protocols, such as TCP/IP, and managing the operational flow control between other hardware modules, and a power supply unit 18 for providing each hardware components with required operational power. The microprocessor 12 is connected to a network interface chip. 14 whereby to be connected to specific application Internet servers, a display and control module 16 being one with light emitting diode (LED) and a liquid crystal display (LCD) in general whereby to display the types, statuses, and contents of the received messages, wherein the LEDs are used to represent power status, network link and activities and if any message incoming or not presently by its specific different color, a data memory 20 being a random access memory (RAM) whereby to temporarily store the display and audio data which is received from specific application Internet server or to be sent to specific application Internet server, a program memory 22 being a flash memory whereby to store the firmware program executed by the microprocessor 12, a non-volatile memory 24 being another flash memory whereby to store the display and voice data when no power is provided to the ASID, and an audio input/output module 26 being MP3 decoder, voice encoder and voice decoder whereby to record voice, play voice and play MP3 songs stored either in data memory 20 or non-volatile memory 24.

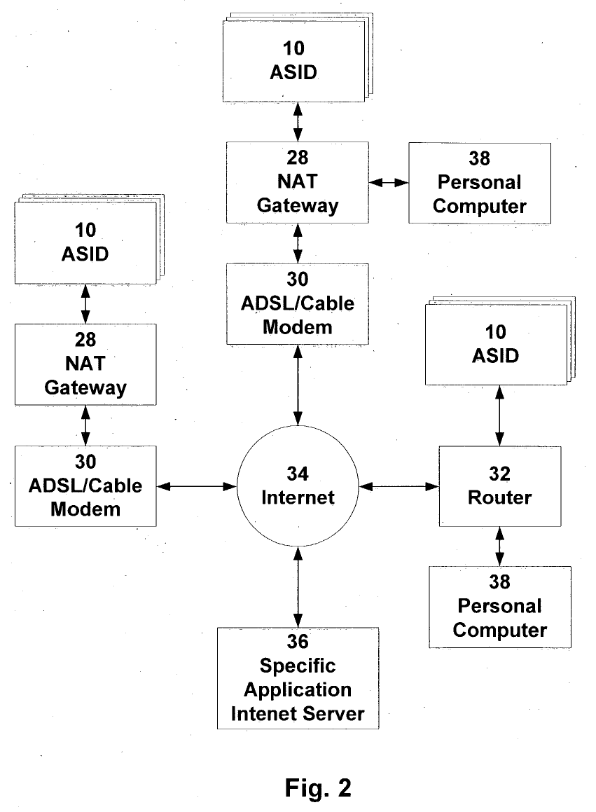

In addition, as shown in FIG. 2, which illustrates the single specific application Internet server system embodiment of the present invention, the application specific Internet device 10 is connected to a personal computer 38 located in local Ethernet network at the initial usage stage, and the application specific Internet device 10 can be employed by using the web browser on the above personal computer 38 for inputting Internet parameters such as Internet Protocol (IP) address of specific application Internet servers and other application parameters related to Internet messaging, for example, login ID and password. Once the application specific Internet device 10 being configured by the process above, it can be brought to any places where the Internet access is available, and works immediately after the power and network is applied on.

Besides the application specific Internet device 10 configuration, the personal computer 38 is connected to specific application Internet server 36 to customize and select services for one application specific Internet device 10, such as setting time zone, defining alarm event, selecting news, and other relative services.

After the entry of the specific application Internet server Internet protocol (IP) address and other relative application parameters into the application specific Internet device 10 in advance, the application specific Internet device 10 may communicate with the server program of specific application Internet server 36 and particular protocols thereof to perform Internet messaging continuously through the NAT (Network Address Translation) gateway 28 or router 32. That is, power-on of the personal computer is no longer needed as the application specific Internet device 10 carries out operations, such as sustained Internet connection and Internet message management, with the specific application Internet server 36 alone. Once receiving messages or data from the specific application Internet server 36, the network interface chip 14 transmits a signal to the microprocessor 12, and after differentiating the property of this signal, the microprocessor 12 accordingly transmits a control signal to the display and control module 16, thereby displaying all incoming new messages and data update statuses, and playing the music or voice possibly contained in the messages, and may save the data in non-volatile memory 24. On the opposite way, voice inputted to audio input/output module 26 is encoded, compressed, sent to microprocessor 12, and then may be further sent to specific application Internet server 36 with the pre-entered designate destination (another specific application Internet device 10) or save the data in non-volatile memory 24. When specific application Internet server 36 receives the voice from one application specific Internet device 10, it sends the data to the designate destination application specific Internet device 10. By incorporating this operation in both directions between any two application specific Internet devices 10, a virtual connection is established and real-time voice streaming is achieved.

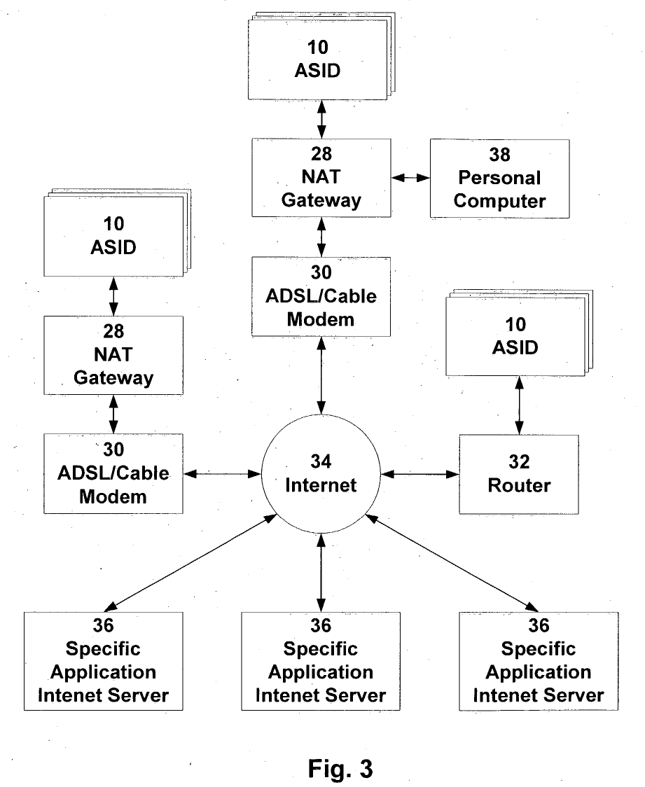

FIG. 3 shows another application specific Internet system embodiment, which contains multiple specific application Internet servers, of the present invention. Service programs, such as voice mail, telephony, news, stock, weather and so on, reside in different specific application Internet servers 36 to handle the large amount of data traffic from application specific Internet devices 10. One of the specific application Internet servers 36 is set to be the main server, and manages the server coordination, database synchronization, user accounts, and other related information.

Since the present invention merely accesses the Internet messages to be browsed and needs no other complicated operations and processes such as application program installation, hardware and memory configuration, and so on, simple structure and low cost can be achieved, and a computer (or host) for inputting system parameters to specific application Internet device is only needed at the initial usage. Afterward, the personal computer can be shutdown, and the present invention may adopt a self-provided power supply or battery set to accomplish simple Internet messaging and control tasks independently. Therefore, the present invention not only solves the conventional disadvantages and inconveniences effectively and provides an application specific Internet device with easy operation, but also saves the power wasted during the power-on period of the personal computer.

While the features of the present invention have been described by the above embodiments, which enable one skilled in the art to appreciate the content of the invention and implement it accordingly, they should not be considered as limited thereby. Other equivalent modifications or alternations performed without departing from the spirit disclosed in the present invention should be included within the following claims.

What is claimed is:

1. An application specific Internet system comprising:
multiple application server programs residing in one or multiple specific application Internet servers; and
multiple application specific Internet devices being connected to specific application Internet servers for transmitting and receiving data, including music data, voice data and display data.

2. The application server Internet system according to claim 1, wherein said application server program is an application program providing a single service, such as voice mail, telephony, news browsing, stock quotation and weather report, to application specific Internet device.

3. An application specific Internet device comprising:
a network interface chip for providing a connection to at least one specific application Internet server;
a microprocessor being connected to said network interface chip for processing protocol interpreter and managing the operational flow control between each device;
a display and control module being connected to said microprocessor for being controlled by said microprocessor to display message statuses;
a program memory being connected to said microprocessor for storing firmware code;
a data memory being connected to said microprocessor for temporarily storing music, voice and display data;
a non-volatile memory connected to said microprocessor for storing music, voice, and display data no power circumstances;
a audio input/output module connected said microprocessor for music playing, voice decoding and voice encoding; and
a power supply unit for providing each hardware components with required operational power.

4. The application specific Internet device according to claim 3, wherein said display and control module is selected from one among a simple light emitting diode (LED), buttons, and a liquid crystal display (LCD), or a more complicated official or domestic Internet appliance.

5. The application specific Internet device according to claim 3, wherein said audio input/output module further comprises a MP3 decoder, voice encoder, voice decoder, a speaker, a headphone/earphone output, and a microphone.

6. The application specific Internet device according to claim 3, wherein said data memory is SRAM or DRAM.

7. The application specific Internet device according to claim 3, wherein said program memory and non-volatile memory are flash memory.

8. The application specific Internet device according to claim 3, wherein said power supply unit is exchanged by a battery set.

9. The application specific Internet device according to claim 3, wherein at least one system parameter and application parameters related to Internet messaging are inputted to said network interface chip through a client program or web browser inside said computer in the manner of local broadcasting even if said computer is shutdown.

10. The application specific Internet device according to claim 9, wherein said system parameter includes an Internet protocol (IP) address of general and particular applications.
